(19) United States
(12) Patent Application Publication
(10) Pub. No.: US 2021/0224607 A1
(43) Pub. Date: Jul. 22, 2021

(54) METHOD AND APPARATUS FOR NEUTRAL NETWORK TRAINING, METHOD AND APPARATUS FOR IMAGE GENERATION, AND STORAGE MEDIUM

(71) Applicant: Beijing Sense Time Technology Development Co., Ltd., Beijing (CN)

(72) Inventors: Yubin DENG, Beijing (CN); Bo DAI, Beijing (CN); Yuanbo XIANGLI, Beijing (CN); Dahua LIN, Beijing (CN); Chen Change LOY, Beijing (CN)

(21) Appl. No.: 17/221,096

(22) Filed: Apr. 2, 2021

Related U.S. Application Data
(63) Continuation of application No. PCT/CN2019/124541, filed on Dec. 11, 2019.

(30) Foreign Application Priority Data
Sep. 27, 2019 (CN) 201910927729.6

(51) Int. Cl. G06K 9/62; G06T 7/00; G06N 3/04; G06N 3/08

(52) U.S. Cl. CPC G06K 9/6262; G06T 7/0002; G06K 9/6257; G06T 2207/20084; G06N 3/084; G06T 2207/20076; G06T 2207/20081; G06N 3/0454

(57) ABSTRACT

Provided are a method and apparatus for neutral network training and a method and apparatus for image generation. The method includes that: a first random vector is input to a generator to obtain a first generated image; the first generated image and a first real image are input to a discriminator to obtain a first discriminated distribution and a second discriminated distribution; a first network loss of the discriminator is determined based on the first discriminated distribution, the second discriminated distribution, a first target distribution and a second target distribution; a second network loss of the generator is determined based on the first discriminated distribution and the second discriminated distribution; and adversarial training is performed on the generator and the discriminator based on the first network loss and the second network loss.

### CROSS-REFERENCE TO RELATED APPLICATIONS

This application is a continuation of International Patent Application No. PCT/CN2019/124541, filed on Dec. 11, 2019, which claims priority to Chinese Patent Application No. 201910927729.6, filed to the China National Intellectual Property Administration on Sep. 27, 2019 and entitled “Method and Apparatus for Neutral Network Training and Method and Apparatus for Image Generation”. The disclosures of International Patent Application No. PCT/CN2019/124541 and Chinese Patent Application No. 201910927729.6 are hereby incorporated by reference in their entireties.

### BACKGROUND

A Generative Adversarial Network (GAN) may consist of two modules that are a discriminator and a generator respectively. With the inspiration of a zero-sum game, the discriminator and generator networks may achieve the best generation effect by mutual rival. In a training process, the discriminator may distinguish, by rewarding a real target and punishing a false target, real image data and an artificial image generated by the generator; the generator may gradually reduce punishments of the discriminator on the false target such that the discriminator cannot distinguish a real image and a generated image; and finally the effect of mixing the false with the genuine may be achieved based on the game and evolution of the discriminator and the generator.

For the GAN, the realness of an input picture may be described by a single scalar output by the discriminator, and then, the scalar is used to calculate a loss of the network and the GAN may be trained.

### SUMMARY

The present disclosure relates to the technical field of computers, and more particularly, to a method and apparatus for neutral network training and a method and apparatus for image generation.

According to an aspect of the present disclosure, a method for neutral network training is provided, which may include the following operations.

A first random vector is input to a generator to obtain a first generated image.

The first generated image and a first real image are input to a discriminator to obtain a first discriminated distribution of the first generated image and a second discriminated distribution of the first real image. The first discriminated distribution represents a probability distribution of a real extent of the first generated image, and the second discriminated distribution represents a probability distribution of a real extent of the first real image.

A first network loss of the discriminator is determined based on the first discriminated distribution, the second discriminated distribution, a preset first target distribution and a preset second target distribution. The first target distribution is a target probability distribution of a generated image, and the second target distribution is a target probability distribution of a real image.

A second network loss of the generator is determined based on the first discriminated distribution and the second discriminated distribution.

Adversarial training is performed on the generator and the discriminator based on the first network loss and the second network loss.

According to an aspect of the present disclosure, an apparatus for neutral network training is provided, which may include: a generation module, a discrimination module, a first determination module, a second determination module, and a training module.

The generation module is configured to input a first random vector to a generator to obtain a first generated image.

The discrimination module is configured to input the first generated image and a first real image to a discriminator to obtain a first discriminated distribution of the first generated image and a second discriminated distribution of the first real image, wherein the first discriminated distribution represents a probability distribution of a real extent of the first generated image, and the second discriminated distribution represents a probability distribution of a real extent of the first real image.

The first determination module is configured to determine a first network loss of the discriminator based on the first discriminated distribution, the second discriminated distribution, a preset first target distribution and a preset second target distribution, wherein the first target distribution is a target probability distribution of a generated image, and the second target distribution is a target probability distribution of a real image.

The second determination module is configured to determine a second network loss of the generator based on the first discriminated distribution and the second discriminated distribution.

The training module is configured to perform adversarial training on the generator and the discriminator based on the first network loss and the second network loss.

According to an aspect of the present disclosure, an apparatus for image generation is provided, which may include: an acquisition module and an obtaining module.

The acquisition module is configured to acquire a third random vector.

The obtaining module is configured to input the third random vector to a trained generator and process the third random vector to obtain a target image.

According to an aspect of the present disclosure, an electronic device is provided, which may include:

a processor; and

memory, configured to store instructions executable by the processor.

The processor is configured to execute the above method.

According to an aspect of the present disclosure, a computer-readable storage medium is provided, which stores computer program instructions that, when executed by a processor, implement the above method.

According to an aspect of the present disclosure, a computer program is provided, which may include a computer-readable code that, when running in an electronic device, enables a processor in the electronic device to implement the above method.

It is to be understood that the above general descriptions and detailed descriptions below are only exemplary and explanatory and not intended to limit the present disclosure.

### BRIEF DESCRIPTION OF THE DRAWINGS

According to the following detailed descriptions on the exemplary embodiments with reference to the accompanying drawings, other characteristics and aspects of the present disclosure become apparent.

The accompanying drawings, which are incorporated in and constitute a part of this specification, illustrate embodiments consistent with the present disclosure and, together with the description, serve to explain the principles of the present disclosure.

FIG. 1 illustrates a flowchart of a method for neutral network training according to an embodiment of the present disclosure.

FIG. 2 illustrates an application schematic diagram of a method for neutral network training according to an embodiment of the present disclosure.

FIG. 3 illustrates a block diagram of an apparatus for neutral network training according to an embodiment of the present disclosure.

FIG. 4 illustrates a block diagram of an electronic device according to an embodiment of the present disclosure.

FIG. 5 illustrates a block diagram of an electronic device according to an embodiment of the present disclosure.

### DETAILED DESCRIPTION

Various exemplary embodiments, features and aspects of the present disclosure will be described below in detail with reference to the accompanying drawings. The same reference signs in the drawings represent components with the same or similar functions. Although each aspect of the embodiments is shown in the drawings, the drawings are not required to be drawn to scale, unless otherwise specified.

Herein, the term “exemplary” means “as an example, embodiment or illustration”. Herein, any “exemplarily” described embodiment may not be explained to be superior to or better than other embodiments.

In the disclosure, the term “and/or” represents an association relationship describing associated objects and means three relationships may exist. For example, A and/or B may represent three conditions: i.e., independent existence of A, existence of both A and B and independent existence of B. In addition, the term “at least one” in the present disclosure represents any one of multiple elements or any combination of at least two of multiple elements. For example, at least one of A, B and C represents any one or more elements selected from a set formed by A, B and C.

In addition, for describing the present disclosure better, many specific details are presented in the following specific implementations. It is to be understood by those skilled in the art that the present disclosure may still be implemented even without some specific details. In some examples, methods, means, components and circuits known very well to those skilled in the art are not described in detail, to highlight the subject of the present disclosure.

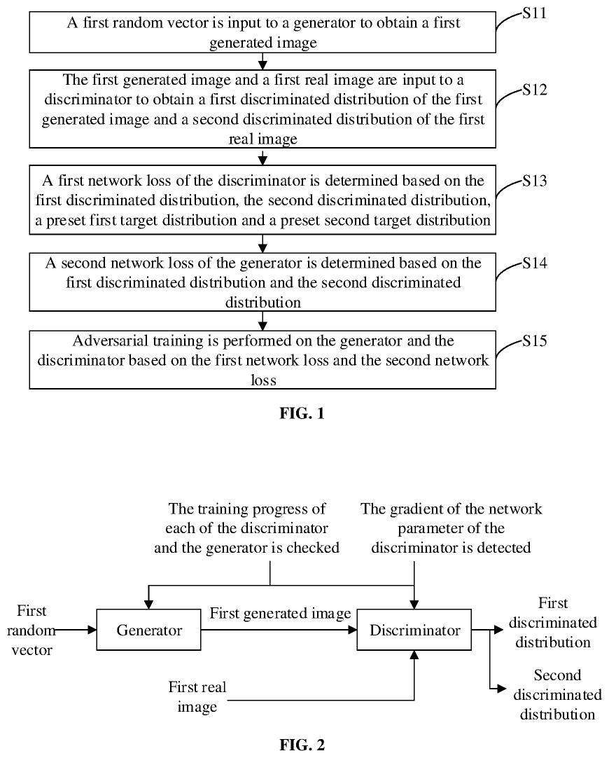

FIG. 1 illustrates a flowchart of a method for neutral network training according to an embodiment of the present disclosure. As shown in FIG. 1, the method may include the following operations.

At S11, a first random vector is input to a generator to obtain a first generated image.

At S12, the first generated image and a first real image are input to a discriminator to obtain a first discriminated distribution of the first generated image and a second discriminated distribution of the first real image. The first discriminated distribution represents a probability distribution of a real extent of the first generated image, and the second discriminated distribution represents a probability distribution of a real extent of the first real image.

At S13, a first network loss of the discriminator is determined based on the first discriminated distribution, the second discriminated distribution, a preset first target distribution and a preset second target distribution. The first target distribution is a target probability distribution of a generated image, and the second target distribution is a target probability distribution of a real image.

At S14, a second network loss of the generator is determined based on the first discriminated distribution and the second discriminated distribution.

At S15, Adversarial training is performed on the generator and the discriminator based on the first network loss and the second network loss.

According to the method for neutral network training provided by the embodiment of the present disclosure, the discriminator may output a discriminated distribution for an input image, describe authenticity of the input image in the form of the probability distribution, describe the probability that the input image is a real image from such aspects as color, texture, proportion and background, and consider the authenticity of the input image from multiple aspects, such that an information loss is reduced, more comprehensive supervision information and a more accurate training direction may be provided for neutral network training and a training precision may be improved. The quality of a generated image may be improved, and thus the generator may be applied to generation of a high-definition image. Furthermore, the target probability distribution of the generated image and the target probability distribution of the real image may be preset to guide the training process, and the real image and the generated image may be guided to approach to their respective target probability distributions in the training process, such that the discrimination between the real image and the generated image is increased, the capability of the discriminator to discriminate the real image and the generated image is enhanced, and thus the quality of the image generated by the generator is improved.

In an implementation, the method for neutral network training may be implemented by a terminal device or a processing device of another type. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device and the like. The processing device of another type may be a server or a cloud server or the like. In some implementations, the method for neutral network training may be implemented by enabling a processor to call a computer-readable instruction stored in memory.

In an implementation, the neutral network may be a GAN consisting of a generator and a discriminator. The generator may be a deep learning neutral network such as a convolutional neural network, and there are no limits made on the type and structure of the generator in the present disclosure. The discriminator may be a deep learning neutral network such as a convolutional neural network, and there are no limits made on the type and structure of the discriminator in the present disclosure. The generator may process a random vector to obtain a generated image. The random vector may be a vector with a random number of elements, and may be obtained by random sampling or the like. In operation S11, the first random vector may be obtained by random sampling or the like, and the generator may perform processing such as convolution on the first random vector to obtain a first generated image corresponding to the first random vector. The first random vector is a randomly generated vector, so that the first generated image is a random image.

In an implementation, the first real image may be any real image, for example, a real image photographed by an image acquisition apparatus (like a camera and a photographing head). In operation S12, the first real image and the first generated image may be input to the discriminator to obtain a first discriminated distribution of the first generated image and a second discriminated distribution of the first real image. Each of the first discriminated distribution and the second discriminated distribution may be a parameter in the form of a vector. For example, a probability distribution may be represented by a vector. The first discriminated distribution may represent the real extent of the first generated image, i.e., the probability that the first generated image is the real image may be described by the first discriminated distribution. The second discriminated distribution may represent the real extent of the first real image, i.e., the probability that the first real image is the real image may be described by the second discriminated distribution. The realness of the image may be described through a distribution (such as a multi-dimensional vector). The realness of the image may be considered from multiple aspects such as color, texture, proportion and background, such that an information loss is reduced, and an accurate direction may be provided for training.

In an implementation, in operation S13, a target probability distribution (i.e., the second target distribution) of the real image, and a target probability distribution (i.e., the first target distribution) of the generated image may be preset. During training, a network loss corresponding to the generated image and a network loss corresponding to the real image may be determined according to the target probability distribution of the real image and the target probability distribution of the generated image, and a parameter of the discriminator may be adjusted based on the network loss corresponding to the generated image and the network loss corresponding to the real image, such that the second discriminated distribution of the real image approaches to the second target distribution and is significantly different from the first target distribution, and the first discriminated distribution of the generated image approaches to the first target distribution and is significantly different from the second target distribution, the discrimination between the real image and the generated image may be increased, the capability of the discriminator to distinguish the real image and the generated image is enhanced, and thus the quality of the image generated by the generator is improved.

In an example, an anchor distribution (i.e., the first target distribution) of the generated image and an anchor distribution (i.e., the second target distribution) of the real image may be preset. The vector representing the anchor distribution of the generated image is significantly different from the vector representing the anchor distribution of the real image. For example, a fixed distribution U may be preset, and it is assumed that the first target distribution A1=U and the second target distribution A2=U+1. During training, the difference between the first discriminated distribution and the anchor distribution of the generated image may be narrowed by adjusting the network parameter of the discriminator. In this process, the difference between the first discriminated distribution and the anchor distribution of the real image is increased. During training, the difference between the second discriminated distribution and the anchor distribution of the real image may be narrowed by adjusting the network parameter of the discriminator. In this process, the difference between the second discriminated distribution and the anchor distribution of the generated image is increased. That is, anchor distributions may be preset for the real image and the generated image, such that the distribution difference between the real image and the generated image is increased, and thus the capability of the discriminator to distinguish the real image and the generated image is improved.

In an implementation, operation S13 may include that: a first distribution loss of the first generated image is determined based on the first discriminated distribution and the first target distribution; a second distribution loss of the first real image is determined based on the second discriminated distribution and the second target distribution; and the first network loss is determined based on the first distribution loss and the second distribution loss.

In an example, the first target distribution may be an accurate probability distribution, and the first distribution loss may be determined by determining a difference between the first target distribution and the first discriminated distribution.

In an implementation, the network loss (i.e., the first distribution loss) corresponding to the first generated image may be determined based on the first discriminated distribution and the first target distribution. The operation that the first distribution loss of the first generated image is determined based on the first discriminated distribution and the first target distribution may include that: the first discriminated distribution is mapped to a support set of the first target distribution to obtain a first mapping distribution; a first relative entropy between the first mapping distribution and the first target distribution is determined; and the first distribution loss is determined based on the first relative entropy.

In an implementation, support sets (the support set is a topological space representing a distribution range of a probability distribution) of the first discriminated distribution and the first target distribution may be different, i.e., the distribution range of the first discriminated distribution is different from that of the first target distribution.

When the distribution ranges are different, there is no significance for comparison in the differences between the two probability distributions. Hence, the first discriminated distribution may be mapped to the support set of the first target distribution, or the first target distribution may be mapped to the support set of the first discriminated distribution, or both the first discriminated distribution and the first target distribution are mapped to the same support set, i.e., the difference between the two probability distributions may be compared in the same distribution range by enabling the distribution range of the first discriminated distribution and the distribution range of the first target distribution to be the same. In an example, the first discriminated distribution may be mapped to the support set of the first target distribution by linear conversion or the like. For example, the first discriminated distribution may be projected through a projection matrix. That is, the linear conversion may be performed on vectors of the first discriminated distribution, and vectors obtained by the conversion form the first mapping distribution mapped to the support set of the first target distribution.

In an implementation, the first relative entropy, i.e., a Kullback-Leibler (KL) distance, between the first mapping distribution and the first target distribution may be determined. The first relative entropy may represent the difference between two probability distributions in the same support set (i.e., the difference between the first mapping distribution and the first target distribution). In another implementation, the difference between the first mapping distribution and the first target distribution may also be determined in anther manner such as a Jensen-Shannon (JS) divergence or a Wasserstein distance.

In an implementation, the first distribution loss (i.e., the network loss corresponding to the generated image) may be determined based on the first relative entropy. In an example, the first relative entropy may be determined as the first distribution loss or operation processing may be performed on the first relative entropy to obtain the first distribution loss. For example, the processing such as weighting, logarithm taking and exponent taking may be performed on the first relative entropy. There are no limits made on the mode for determining the first distribution loss in the present disclosure.

In an example, the second target distribution may be an accurate probability distribution, and the second distribution loss may be determined by determining a difference between the second target distribution and the second discriminated distribution.

In an implementation, the network loss (i.e., the second distribution loss) corresponding to the first real image may be determined based on the second discriminated distribution and the second target distribution. The operation that the second distribution loss of the first real image is determined based on the second discriminated distribution and the second target distribution may include that: the second discriminated distribution is mapped to a support set of the second target distribution to obtain a second mapping distribution; a second relative entropy between the second mapping distribution and the second target distribution is determined; and the second distribution loss is determined based on the second relative entropy.

In an implementation, support sets (the support set is a topological space representing a distribution range of the probability distribution) of the second discriminated distribution and the second target distribution may be different, i.e., the distribution range of the second discriminated distribution is different from that of the second target distribution. The second discriminated distribution may be mapped to the support set of the second target distribution, or the second target distribution may be mapped to the support set of the second discriminated distribution, or both the second discriminated distribution and the second target distribution are mapped to the same support set, such that the distribution range of the second discriminated distribution and the distribution range of the second target distribution are the same. The difference between the two probability distributions may be compared in the same distribution range. In an example, the second discriminated distribution may be mapped to the support set of the second target distribution by linear conversion or the like. For example, the second discriminated distribution may be projected through a projection matrix, i.e., the linear conversion may be performed on vectors of the second discriminated distribution, and vectors obtained by the conversion form the second mapping distribution mapped to the support set of the second target distribution.

In an implementation, the second relative entropy between the second mapping distribution and the second target distribution may be determined. The second relative entropy may represent the difference between two probability distributions in the same support set (i.e., the differences between the second mapping distribution and the second target distribution). The method for calculating the second relative entropy is similar to that for calculating the first relative entropy, and will not be repeated herein. Certainly, in another implementation, the difference between the second mapping distribution and the second target distribution may also be determined in another manner such as a JS divergence or a Wasserstein distance.

In an implementation, the second distribution loss (i.e., the network loss corresponding to the generated image) may be determined based on the second relative entropy. In an example, the second relative entropy may be determined as the second distribution loss or operation processing may be performed on the second relative entropy to obtain the second distribution loss. For example, the processing such as weighting, logarithm taking and exponent taking is performed on the second relative entropy. There are no limits made on the mode for determining the second distribution loss in the present disclosure.

In an implementation, the first network loss may be determined based on the first distribution loss of the first generated image and the second distribution loss of the second generated image. The operation that the first network loss is determined based on the first distribution loss and the second distribution loss may include that: weighted summation processing is performed on the first distribution loss and the second distribution loss to obtain the first network loss. In an example, the first distribution loss may be the same as the second distribution loss in weight, i.e., the first network loss may be obtained by summarizing the first distribution loss and the second distribution loss. Or, the first distribution loss may be different from the second distribution loss in weight, i.e., the first network loss may be obtained by multiplying the first distribution loss and the second distribution loss by respective weights and then performing summation. The weights of the first distribution loss and the second distribution loss may be preset, and there are no limits made on the weights of the first distribution loss and the second distribution loss.

In such a manner, the target probability distribution of the generated image and the target probability distribution of the real image may be preset to guide the training process, the distribution losses may be determined, and the real image and the generated image may be guided to approach to their respective target probability distributions in the training process, such that the discrimination between the real image and the generated image is increased, more accurate angular information and a more accurate training direction may be provided for the discriminator, the capability of the discriminator to discriminate the real image and the generated image is enhanced, and thus the quality of the image generated by the generator is improved.

In an implementation, a second network loss of the generator may further be determined. In an example, the discriminator needs to discriminate whether the input image is the real image or the generated image. Hence, the discriminator may enhance the capability of distinguishing the real image and the generated image during training, i.e., making the discriminated distributions of the real image and the generated image approach to the respective target probability distributions, thereby increasing the discrimination between the real image and the generated image. However, the generator is to make the generated image approach to the real image, i.e., making the generated image vivid enough, such that it is hard for the discriminator to identify the generated image output by the generator. When the adversarial training reaches to a balanced state, the performances of both the discriminator and the generator are strong, i.e., the discriminator has a very strong discrimination capability and can distinguish the real image and the generated image with a low real extent, and the image generated by the generator has a very high real extent such that it is hard for the discriminator to distinguish the high-quality generated image. During the adversarial training, the improved performance of the discriminator may promote the improvement in the performance of the generator, i.e., the stronger the capability of the discriminator to distinguish the real image and the generated image, the higher the real extent of the image generated by the generator.

The generator may be trained in order to improve the real extent of the generated image, i.e., making the generated image approach to the real image. In other words, the training of the generator may make the first discriminated distribution of the first generated image approach to the second discriminated distribution of the first real image, such that the discrimination is hard for the discriminator. In an implementation, operation S14 may include that: a third relative entropy between the first discriminated distribution and the second discriminated distribution is determined, and the second network loss is determined based on the third relative entropy.

In an implementation, the third relative entropy between the first discriminated distribution and the second discriminated distribution may be determined, and the third relative entropy may represent a difference between two probability distributions in the same support set (i.e., the difference between the third mapping distribution and the fourth mapping distribution). The method for calculating the third relative entropy is similar to that for calculating the first relative entropy, and will not be repeated herein. In another implementation, the difference between the first discriminated distribution and the second discriminated distribution may also be determined in another manner such as a JS divergence or a Wasserstein distance, so as to determine the network loss of the generator through the difference therebetween.

In an implementation, the second network loss may be determined based on the third relative entropy. In an example, the third relative entropy may be determined as the second network loss; or operation processing may be performed on the third relative entropy, for example, performing weighting, logarithm taking and exponent taking on the third relative entropy, to obtain the second network loss. There are no limits made on the mode for determining the second network loss in the present disclosure.

In an implementation, support sets of the first discriminated distribution and the second discriminated distribution are different, i.e., the first discriminated distribution may be different from the discriminated distribution in distribution range. The support sets of the first discriminated distribution and the second discriminated distribution may coincide via linear conversion. For example, the first discriminated distribution and the second discriminated distribution may be mapped to a target support set, such that the distribution range of the second discriminated distribution and the distribution range of the second target distribution are the same. The difference between the two probability distributions may be compared in the same distribution range.

In an example, the target support set may be the support set of the first discriminated distribution or the support set of the second discriminated distribution. The second discriminated distribution may be mapped to the support set of the first discriminated distribution by linear conversion or the like, i.e., the linear conversion may be performed on vectors of the second discriminated distribution, vectors obtained after the conversion form the fourth mapping distribution mapped to the support set of the first discriminated distribution, and the first discriminated distribution is used as the third mapping distribution. Or, the first discriminated distribution may be mapped to the support set of the second discriminated distribution by linear conversion or the like, i.e., the linear conversion may be performed on vectors of the first discriminated distribution, vectors obtained after the conversion form the third mapping distribution mapped to the support set of the second discriminated distribution, and the second discriminated distribution is used as the fourth mapping distribution.

In an example, the target support set may also be another support set. For example, the support set may be preset, and both the first discriminated distribution and the second discriminated distribution may be mapped to the support set to obtain the third mapping distribution and the fourth mapping distribution. Further, a third relative entropy between the third mapping distribution and the fourth mapping distribution may be calculated. There are no limits made on the target support set in the present disclosure.

In such a manner, the generator may be trained by reducing a difference between the first discriminated distribution and the second discriminated distribution, such that the performance of the discriminator is improved and the performance of the generator is also improved. Thus, the generated image with a higher real extent is generated, and the generator may be applied to generation of a high-definition image.

In an implementation, the generator and the discriminator may be subjected to adversarial training based on the first network loss of the discriminator and the second network loss of the generator. With the training, the performances of the generator and the discriminator are both improved, the discrimination capability of the discriminator is improved, the capability of the generator to generate the generated image with a higher real extent is improved, and the generator and the discriminator reach a balanced state.

Optionally, operation S15 may include that: a network parameter of the discriminator is adjusted based on the first network loss; a network parameter of the generator is adjusted based on the second network loss and the trained generator and discriminator are obtained when the discriminator and the generator meet a training condition.

During training, due to such factors as different complexities of the network parameters, the training progress of the discriminator is typically ahead of that of the generator. However, when the progress of the discriminator is fast and the discriminator is trained completely in advance, a gradient in back propagation cannot be provided for the generator, such that the parameter of the generator cannot be updated, i.e., the performance of the generator cannot be improved. Hence, the performance of the image generated by the generator is limited, so that the generator cannot be applied to generation of a high-definition image and a real extent of an image is low.

In an implementation, a gradient for adjusting the network parameter of the discriminator in the training process of the discriminator may be limited. The operation that the network parameter of the discriminator is adjusted based on the first network loss may include that: a second random vector is input to the generator to obtain a second generated image; interpolation processing is performed on a second real image based on the second generated image to obtain an interpolated image; the interpolated image is input to the discriminator to obtain a third discriminated distribution of the interpolated image; a gradient of the network parameter of the discriminator is determined based on the third discriminated distribution; a gradient punishment parameter is determined based on the third discriminated distribution when the gradient is larger than or equal to a gradient threshold; and the network parameter of the discriminator is adjusted based on the first network loss and the gradient punishment parameter.

In an implementation, the second random vector may be obtained by random sampling or the like, and input to the generator to obtain the second generated image, i.e., obtaining an unreal image. The second generated image may also be obtained in another manner, for example, an unreal image may be generated directly and randomly.

In an implementation, the interpolation processing may be performed on the second generated image and the second real image to obtain the interpolated image, i.e., the interpolated image is a composite image of a real image and an unreal image. The interpolated image includes a part of the real image and also includes a part of the unreal image. In an example, random nonlinear interpolation may be performed on the second real image and the second generated image to obtain the interpolated image, and there are no limits made on a mode for obtaining the interpolated image.

In an implementation, the interpolated image may be input to the discriminator to obtain the third discriminated distribution of the interpolated image, i.e., the discriminator may discriminate the composite image of the real image and the unreal image to obtain the third discriminated distribution.

In an implementation, the third discriminated distribution may be used to determine the gradient of the network parameter of the discriminator. For example, a target probability distribution of the interpolated image may be preset (such as the target probability distribution capable of representing that the probability of the interpolated image being the real image is 50%), and the gradient of the network parameter of the discriminator may be determined based on a relative entropy between the third discriminated distribution and the target probability distribution. For example, back propagation may be performed on the relative entropy between the third discriminated distribution and the target probability distribution to calculate a partial differential between the relative entropy and each network parameter of the discriminator, thereby obtaining the gradient of the network parameter. Certainly, in another implementation, the parameter gradient of the discriminator may also be determined based on a difference between the third discriminated distribution and another type such as the JS divergence of the target probability distribution.

In an implementation, the gradient punishment parameter may be determined based on the third discriminated distribution when the gradient of the network parameter of the discriminator is larger than or equal to the preset gradient threshold. The gradient threshold may be a threshold for limiting the gradient. When a gradient is large, the descending speed of the gradient may be fast during training (i.e., for a large training step, the speed that the network trends to be the minimum value is fast), so the gradient may be limited by the gradient threshold. In an example, the gradient threshold may be set as 10, 20 or the like, and there are no limits made on the gradient threshold in the present disclosure.

In an example, with the gradient punishment parameter, the gradient of the network parameter that exceeds the gradient threshold may be adjusted, or the gradient descending speed may be limited, such that the gradient of the parameter is gentle and the gradient descending speed is reduced. For example, the gradient punishment parameter may be determined based on an expected value of the third discriminated distribution. The gradient punishment parameter may be a compensation parameter for gradient descent. For example, the multiplier of the partial differential may be adjusted through the gradient punishment parameter, or the gradient descending direction may be changed through the gradient punishment parameter, so as to limit the gradient, thereby reducing the gradient descending speed of the network parameter of the discriminator, and preventing the gradient of the discriminator from descending fast to cause early convergence of the discriminator (early completion of the training). In an example, the third discriminated distribution may be a probability distribution. The expected value of the probability distribution may be calculated, and the gradient punishment parameter may be determined based on the expected value, for example, the expected value may be determined as the multiplier of the partial differential of the network parameter, i.e., the expected value is determined as the gradient punishment parameter, and the gradient punishment parameter is used as the multiplier of the gradient. There are no limits made on a mode for determining the gradient punishment parameter in the present disclosure.

In an implementation, the network parameter of the discriminator may be adjusted based on the first network loss and the gradient punishment parameter. In the process of performing back propagation on the first network loss to reduce the gradient, the gradient punishment parameter may be added, such that the gradient is prevented from descending fast while the network parameter of the discriminator is adjusted, i.e., early training completion of the discriminator is prevented. For example, the gradient punishment parameter may be used as the multiplier of the partial differential, i.e., the multiplier of the gradient, so as to alleviate the gradient descending speed and prevent the early training completion of the discriminator.

In an implementation, when the gradient of the network parameter of the discriminator is smaller than the preset gradient threshold, the network parameter of the discriminator may be adjusted based on the first network loss, i.e., back propagation may be performed on the first network loss such that the gradient and the first network loss are reduced.

In an implementation, when the network parameter of the discriminator is adjusted, whether the gradient of the discriminator is larger than or equal to the gradient threshold may be checked. The gradient punishment parameter may be set when the gradient of the discriminator is larger than or equal to the gradient threshold. Or, the gradient of the discriminator may not be checked but the training progress of the discriminator is controlled in another manner (for example, adjustment of the network parameter of the discriminator is suspended but only the network parameter of the generator is adjusted, etc.).

In such a manner, the gradient descending speed of the discriminator during training may be limited by detecting whether the gradient of the network parameter of the discriminator is larger than or equal to the gradient threshold, thereby limiting the training progress of the discriminator and reducing a probability that the discriminator has a vanishing gradient. Thus, the generator may be optimized sustainably, the performance of the generator is improved, the real extent of an image generated by the generator is higher, and the generator may be applied to generation of a high-definition image.

In an implementation, the network parameter of the generator may be adjusted based on the second network loss. For example, the back propagation may be performed on the second network loss to reduce the gradient, such that the second network loss is reduced, and the performance of the generator is improved.

In an implementation, when adversarial training is performed on the discriminator and the generator and the network parameter of the discriminator is adjusted based on the first network loss, the network parameter of the generator keeps unchanged. When the network parameter of the generator is adjusted based on the second network loss, the network parameter of the discriminator keeps unchanged. The above training process is executed iteratively till both the discriminator and the generator meets a training condition. In an example, the training condition may include that the discriminator and the generator reach a balanced state. For example, the network loss of each of the discriminator and the generator is less than or equal to the preset threshold, or is converged to a preset interval. Or, the training condition may include that the following two conditions reach a balanced state: first, the network loss of the generator is less than or equal to the preset threshold or is converged to the preset interval; and second, the probability that the input image represented by the discriminated distribution and output by the discriminator is the real image is maximized In this case, the capability of the discriminator to distinguish the real image and the generated image is strong, and the image generated by the generator has high quality and a high real extent.

In an implementation, not only whether the gradient of the discriminator is larger than or equal to the gradient threshold is checked, but also the probability that the discriminator has a vanishing gradient may further be reduced by controlling the training progress of the discriminator.

In an implementation, the training progress of each of the discriminator and the generator may be checked at the end of any training period. Specifically, operation S15 may include that: the first random vector input to a generator in at least one historical training period is input to a generator in a present training period to obtain at least one third generated image; the first generated image corresponding to the first random vector input to the generator in the at least one historical training period, the at least one third generated image and at least one real image are input to a discriminator in the present training period to obtain a fourth discriminated distribution of at least one first generated image, a fifth discriminated distribution of the at least one third generated image and a sixth discriminated distribution of the at least one real image; a training progress parameter of the generator in the present training period is determined based on the fourth discriminated distribution, the fifth discriminated distribution and the sixth discriminated distribution; and the network parameter of the discriminator is stopped from being adjusted but only the network parameter of the generator is adjusted when the training progress parameter is smaller than or equal to a training progress threshold.

In an implementation, a buffer, such as an experience buffer, may be created during the training. In the buffer, a first random vector of at least one historical training period (such as M periods, the M being a positive integer) and M first generated images generated by the generator based on the first random vectors in the above M historical training periods may be stored, i.e., one first generated image may be generated by one first random vector in each historical training period, and in the buffer, first random vectors of the M historical training periods as well as the generated M first generated images may be stored. With the advancement of the training, when the number of training periods exceeds the M, a first random vector and a first generated image in the latest training period may be used to replace the first random vector and the first generated image stored to the buffer at the earliest.

In an implementation, the first random vector input to the generator in the at least one historical training period may be input to the generator in the present training period to obtain the at least one third generated image. For example, m (the m is smaller than or equal to the M, and the m is a positive integer) first random vectors in the buffer may be input to the generator in the present training period to obtain m third generated images.

In an implementation, the m third generated images may be discriminated by the discriminator in the present training period to obtain m fifth discriminated distributions. First generated images in m historical training periods may be discriminated by the discriminator in the present training period to obtain m fourth discriminated distributions. m real images may be randomly sampled from a database, and the m real images may be discriminated by the discriminator in the present training period to obtain m sixth discriminated distributions.

In an implementation, the training progress of the generator in the present training period may be determined based on the m fourth discriminated distributions, the m fifth discriminated distributions and the m sixth discriminated distributions, i.e., whether the training progress of the discriminator is significantly earlier than that of the generator is determined, and the training progress parameter of the generator is adjusted when it is determined that the training progress of the discriminator is significantly earlier than that of the generator, so as to improve the training progress of the generator, and reduce the training progress difference between the discriminator and the generator. That is, the training of the discriminator is suspended and the generator is independently trained, such that the progress parameter of the generator is improved and the progress is accelerated.

In an implementation, the operation that the training progress parameter of the generator in the present training period is determined based on the fourth discriminated distribution, the fifth discriminated distribution and the sixth discriminated distribution may include that: a first expected value of the at least one fourth discriminated distribution, a second expected value of the at least one fifth discriminated distribution and a third expected value of the at least one sixth discriminated distribution are acquired; a first average value of at least one first expected value, a second average value of the at least one second expected value and a third average value of the at least one third expected value are acquired; a first difference between the third average value and the second average value as well as a second difference between the second average value and the first average value is determined; and a ratio of the first difference to the second difference is determined as the training progress parameter of the generator in the present training period.

In an implementation, expected values of the m fourth discriminated distributions may be calculated to obtain m first expected values, expected values of the m fifth discriminated distributions may be calculated to obtain m second expected values, and expected values of the m sixth discriminated distributions may be calculated to obtain m third expected values. Further, the m first expected values may be averaged to obtain a first average value S_{B}, the m second expected values may be averaged to obtain a second average value S_{G}, and the m third expected values may be averaged to obtain a third average value S_{R}.

In an implementation, a first difference (S_{R}−S_{G}) between the first average value and the second average value may be determined, and a second difference (S_{G}−S_{B}) between the second average value and the first average value may be determined. Further, a ratio (S_{R}−S_{G})/(S_{G}−S_{B}) of the first difference to the second difference may be determined as the training progress parameter of the generator in the present training period. In another example, the preset number of training times may further be used as the training progress parameter of the generator, for example, whenever the generator and the discriminator are jointly trained for 100 times, the training of the discriminator may be suspended, and the generator is independently trained for 50 times; and thereafter, whenever the generator and the discriminator are jointly trained for 100 times . . . till the generator and the discriminator meet the training condition.

In an implementation, a training progress threshold may be set. The training progress threshold is a threshold for determining the training progress of the generator. When the training progress parameter is less than or equal to the training progress threshold, it is indicated that the training progress of the discriminator is significantly ahead of the generator, i.e., the training progress of the generator is slow, and the adjustment on the network parameter of the discriminator may be suspended but only the network parameter of the generator is adjusted. In an example, in the next training period, checking the training progress of each of the discriminator and the generator is repeatedly implemented. The network parameters of the discriminator and the generator cannot be adjusted at the same time until the training progress parameter is larger than the training progress threshold, i.e., the training of the discriminator is suspended by at least one training period but only the generator is trained (i.e., only the network parameter of the generator is adjusted based on the third network loss, and the network parameter of the discriminator keeps unchanged), and the generator and the discriminator are not adversarially trained until the training progress of the generator approaches to the training progress of the discriminator.

In another implementation, the training speed of the discriminator may also be reduced when the training progress parameter is less than or equal to the training progress threshold. For example, the training period of the discriminator is prolonged or the gradient descending speed of the discriminator is reduced, or the like. The training speed of the discriminator cannot be restored until the training progress parameter is larger than the training progress threshold.

In such a manner, the gradient descending speed of the discriminator during training may be limited by checking the training progress of each of the discriminator and the generator, thereby limiting the training progress of the discriminator, and reducing the probability that the discriminator has a vanishing gradient. Thus, the generator may be optimized sustainably, the performance of the generator is improved, the real extent of an image generated by the generator is high, and the generator may be applied to generation of a high-definition image.

In an implementation, upon the completion of the adversarial training of the generator and the discriminator, i.e., the performances of the generator and the discriminator are good, the generator may be used to generate an image, and the generated image has a high real extent.

The present disclosure further provides a method for image generation, which can generate an image by using the above trained GAN.

In some examples of the present disclosure, a method for image generation may include that: a third random vector is acquired; and the third random vector is input to a generator trained with the above method for neutral network training and is processed to obtain a target image.

In an example, the third random vector may be obtained by random sampling or the like, and the third random vector may be input to the trained generator. The generator may output the target image with a high real extent. In an example, the target image may be a high-definition image, i.e., the trained generator may be applied to generating a high-definition image with a high real extent.

According to the method for neutral network training provided by the embodiment of the present disclosure, the discriminator may output a discriminated distribution for an input image, describe realness of the input image through a probability distribution, and consider the realness of the input image from multiple aspects, such that the information loss is reduced, more comprehensive supervision information and a more accurate training direction are provided for neutral network training, the training precision is improved, and the quality of the generated image is improved, and thus the generator may be applied to generation of a high-definition image. Furthermore, the target probability distribution of the generated image and the target probability distribution of the real image may be preset to guide the training process, and the real image and the generated image may be guided to approach to the respective target probability distributions in the training process, such that the discrimination between the real image and the generated image is increased, and the capability of the discriminator to discriminate the real image and the generated image is enhanced; and the generator is trained in the mode of reducing the difference between the first discriminated distribution and the second discriminated distribution, such that the performance of the discriminator is improved and the improvement in the performance of the generator is also promoted, and thus the generated image with a high real extent is generated and the generator may be applied to generation of a high-definition image. Further, the gradient descending speed of the discriminator during training may be limited by detecting whether the gradient of the network parameter of the discriminator is larger than or equal to the gradient threshold, or checking the training progress of each of the discriminator and the generator, thereby limiting the training progress of the discriminator, and reducing a probability that the discriminator has a vanishing gradient. Thus, the generator may be optimized sustainably, the performance of the generator is improved, the real extent of an image generated by the generator is high, and the generator may be applied to generation of a high-definition image.

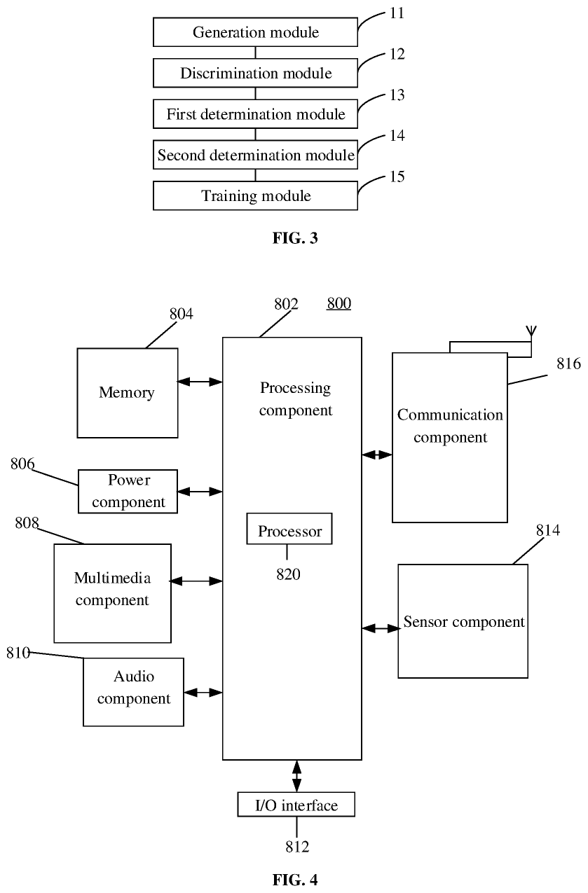

FIG. 2 illustrates an application schematic diagram of a method for neutral network training according to an embodiment of the present disclosure. As shown in FIG. 2, a first random vector may be input to a generator, and the generator may output a first generated image. A discriminator may discriminate the first generated image and a first real image to obtain a first discriminated distribution of the first generated image and a second discriminated distribution of the first real image.

In an implementation, an anchor distribution (i.e., the first target distribution) of the generated image and an anchor distribution (i.e., the second target distribution) of the real image may be preset. A first distribution loss corresponding to the first generated image may be determined based on the first discriminated distribution and the first target distribution. A second distribution loss corresponding to the first real image may be determined based on the second discriminated distribution and the second target distribution. Further, a first network loss of the discriminator may be determined through the first distribution loss and the second distribution loss.

In an implementation, a second network loss of the generator may be determined through the first discriminated distribution and the second discriminated distribution. Further, the generator and the discriminator may be subjected to adversarial training based on the first network loss and the second network loss, i.e., the network parameter of the discriminator is adjusted based on the first network loss, and the network parameter of the generator is adjusted based on the second network loss.

In an implementation, the training progress of the discriminator is typically faster than that of the generator. In order to reduce the probability that the training of the discriminator is completed in advance to cause a vanishing gradient such that the generator cannot be optimized continuously, the gradient of the discriminator may be detected to control the training progress of the discriminator. In an example, interpolation may be performed on one real image and one generated image, a third discriminated distribution of an interpolated image may be determined by the discriminator, and a gradient punishment parameter may be determined based on an expected value of the third discriminated distribution. When the gradient of the discriminator is larger than or equal to the preset gradient threshold, in order to prevent the gradient of the discriminator from descending fast to cause too fast completion of the training of the discriminator, back propagation may be performed on the first network loss, such that the gradient punishment parameter is added in the gradient descending process to limit the gradient descending speed of the discriminator.

In an implementation, the training progress of each of the discriminator and the generator may further be checked, for example, M first random vectors input to the generator in M historical training periods may be input to the generator in the present training period to obtain M third generated images. The training progress parameter of the generator in the present training period may be determined based on first generated images generated in the M historical training periods, the M third generated images and M real images. When the training progress parameter is less than or equal to the training progress threshold, it is indicated that the training progress of the discriminator is significantly ahead of the generator, and the adjustment on the network parameter of the discriminator may be suspended but only the network parameter of the generator is adjusted. In the next training period, checking of the training progress of each of the discriminator and the generator is repeatedly executed. The network parameters of the discriminator and the generator cannot be adjusted at the same time until the training progress parameter is larger than the training progress threshold, i.e., the training of the discriminator is suspended in at least one training period but only the generator is trained.

In an implementation, upon the completion of the adversarial training of the generator and the discriminator, the generator may be used to generate an image, and the generated image may be a high-definition image with a high real extent.

In an implementation, the method for neutral network training may enhance the stability of GAN, and the quality and realness of the generated image. The method for neutral network training may be applied to generation or synthesis of scenarios in games, to migration or conversion of image styles and to image clustering or the like. There are no limits made on use scenarios of the method for neutral network training.

FIG. 3 illustrates a block diagram of an apparatus for neutral network training according to an embodiment of the present disclosure. As shown in FIG. 3, the apparatus may include: a generation module 11, a discrimination module 12, a first determination module 13, a second determination module 14 and a training module 15.

The generation module 11 is configured to input a first random vector to a generator to obtain a first generated image.

The discrimination module 12 is configured to input the first generated image and a first real image to a discriminator to obtain a first discriminated distribution of the first generated image and a second discriminated distribution of the first real image, wherein the first discriminated distribution represents a probability distribution of a real extent of the first generated image, and the second discriminated distribution represents a probability distribution of a real extent of the first real image.

The first determination module 13 is configured to determine a first network loss of the discriminator based on the first discriminated distribution, the second discriminated distribution, a preset first target distribution and a preset second target distribution, wherein the first target distribution is a target probability distribution of a generated image, and the second target distribution is a target probability distribution of a real image.

The second determination module 14 is configured to determine a second network loss of the generator based on the first discriminated distribution and the second discriminated distribution.

The training module 15 is configured to perform adversarial training on the generator and the discriminator based on the first network loss and the second network loss.

In an implementation, the first determination module is further configured to:

determine a first distribution loss of the first generated image based on the first discriminated distribution and the first target distribution;

determine a second distribution loss of the first real image based on the second discriminated distribution and the second target distribution; and

determine the first network loss based on the first distribution loss and the second distribution loss.

In an implementation, the first determination module is further configured to:

map the first discriminated distribution to a support set of the first target distribution to obtain a first mapping distribution;

determine a first relative entropy between the first mapping distribution and the first target distribution; and

determine the first distribution loss based on the first relative entropy.

In an implementation, the first determination module is further configured to:

map the second discriminated distribution to a support set of the second target distribution to obtain a second mapping distribution;

determine a second relative entropy between the second mapping distribution and the second target distribution; and

determine the second distribution loss based on the second relative entropy.

In an implementation, the first determination module is further configured to:

perform weighted summation processing on the first distribution loss and the second distribution loss to obtain the first network loss.

In an implementation, the second determination module is further configured to:

determine a third relative entropy between the first discriminated distribution and the second discriminated distribution; and

determine the second network loss based on the third relative entropy.

In an implementation, the training module is further configured to:

adjust a network parameter of the discriminator based on the first network loss;

adjust a network parameter of the generator based on the second network loss;

and

obtain the trained generator and discriminator when the discriminator and the generator meet a training condition.

In an implementation, the training module is further configured to:

input a second random vector to the generator to obtain a second generated image;

perform interpolation processing on a second real image based on the second generated image to obtain an interpolated image;

input the interpolated image to the discriminator to obtain a third discriminated distribution of the interpolated image;

determine a gradient of the network parameter of the discriminator based on the third discriminated distribution;

determine a gradient punishment parameter based on the third discriminated distribution when the gradient is larger than or equal to a gradient threshold; and

adjust the network parameter of the discriminator based on the first network loss and the gradient punishment parameter.

In an implementation, the training module is further configured to:

input the first random vector input to a generator in at least one historical training period to a generator in a present training period to obtain at least one third generated image;

input the first generated image corresponding to the first random vector input to the generator in the at least one historical training period, the at least one third generated image and at least one real image to a discriminator in the present training period to obtain a fourth discriminated distribution of at least one first generated image, a fifth discriminated distribution of the at least one third generated image and a sixth discriminated distribution of the at least one real image;

determine a training progress parameter of the generator in the present training period based on the fourth discriminated distribution, the fifth discriminated distribution and the sixth discriminated distribution; and

stop adjusting the network parameter of the discriminator but only adjust the network parameter of the generator when the training progress parameter is smaller than or equal to a training progress threshold.

In an implementation, the training module is further configured to:

acquire a first expected value of the at least one fourth discriminated distribution, a second expected value of the at least one fifth discriminated distribution and a third expected value of the at least one sixth discriminated distribution;

acquire a first average value of at least one first expected value, a second average value of the at least one second expected value and a third average value of the at least one third expected value;

determine a first difference between the third average value and the second average value as well as a second difference between the second average value and the first average value is determined; and

determine a ratio of the first difference to the second difference as the training progress parameter of the generator in the present training period.

The present disclosure further provides an apparatus for image generation, which generates an image by using the above trained GAN.

In some examples of the present disclosure, the apparatus for image generation may include: an acquisition module and an obtaining module.

The acquisition module is configured to acquire a third random vector.

The obtaining module is configured to input the third random vector to a trained generator and process the third random vector to obtain a target image.

It can be understood that the method embodiments mentioned in the present disclosure may be combined with each other to form a combined embodiment without departing from the principle and logic, which is not elaborated in the embodiments of the present disclosure for the sake of simplicity.

In addition, the present disclosure further provides an apparatus for neutral network training, an electronic device, a computer-readable storage medium and a program, all of which may be configured to implement any method for neutral network training provided by the present disclosure. The corresponding technical solutions and descriptions refer to the corresponding descriptions in the method and will not be elaborated herein. It may be understood by the person skilled in the art that in the method of the specific implementations, the writing sequence of each operation does not mean a strict execution sequence to form any limit to the implementation process, and the specific execution sequence of each operation may be determined in terms of the function and possible internal logic. In some examples, the function or included module of the apparatus provided by the embodiment of the present disclosure may be configured to execute the method described in the above method embodiments, and the specific implementation may refer to the description in the above method embodiments. For the simplicity, the details are not elaborated herein.

An embodiment of the present disclosure further provides a computer-readable storage medium, which stores computer program instructions thereon. The computer program instructions are executed by a processor to execute the above methods. The computer storage medium may be a transitory computer-readable storage medium or a non-transitory computer-readable storage medium.

An embodiment of the present disclosure further provides an electronic device, which may include: a processor; and memory configured to store instructions executable by the processor, the processor being configured to implement the method. The electronic device may be provided as a terminal, a server or other types of devices.

FIG. 4 illustrates a block diagram of an electronic apparatus 800 according to an exemplary embodiment. For example, the electronic device 800 may be a terminal such as a mobile phone, a computer, a digital broadcast terminal, a messaging device, a gaming console, a tablet, a medical device, exercise equipment and a PDA.

Referring to FIG. 4, the electronic device 800 may include one or more of the following components: a processing component 802, memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the electronic device 800. Examples of such data include instructions for any application or method operated on the electronic device 800, contact data, phonebook data, messages, pictures, videos, etc. The memory 804 may be implemented by using any type of transitory or non-transitory memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 806 provides power to various components of the electronic device 800. The power component 806 may include a power management system, one or more power sources, and any other components associated with the generation, management, and distribution of power in the electronic device 800.

The multimedia component 808 includes a screen providing an output interface between the electronic device 800 and the user. In some examples, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a period of time and a pressure associated with the touch or swipe action. In some examples, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focus and optical zoom capability.

The audio component 810 is configured to output and/or input audio signals.

For example, the audio component 810 includes a Microphone (MIC) configured to receive an external audio signal when the electronic device 800 is in an operation mode, such as a call mode, a recording mode, and a voice recognition mode. The received audio signal may further be stored in the memory 804 or transmitted via the communication component 816. In some examples, the audio component 810 further includes a speaker configured to output audio signals.

The I/O interface 812 provides an interface between the processing component 802 and peripheral interface modules. The peripheral interface modules may be a keyboard, a click wheel, buttons, and the like. The buttons may include, but are not limited to, a home button, a volume button, a starting button, and a locking button.

The sensor component 814 includes one or more sensors to provide status assessments of various aspects of the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor, configured to detect the presence of nearby objects without any physical contact. The sensor component 814 may also include a light sensor, such as a Complementary Metal Oxide Semiconductor (CMOS) or Charge Coupled Device (CCD) image sensor, configured for use in an imaging application. In some examples, the sensor component 814 may also include an accelerometer sensor, a gyroscope sensor, a magnetic sensor, a pressure sensor, or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In one exemplary embodiment, the communication component 816 receives a broadcast signal or broadcast associated information from an external broadcast management system via a broadcast channel In one exemplary embodiment, the communication component 816 further includes a near field communication (NFC) module to facilitate short-range communications. For example, the NFC module may be implemented based on a Radio Frequency Identification (RFID) technology, an Infrared Data Association (IrDA) technology, an Ultra-Wideband (UWB) technology, a Bluetooth (BT) technology, and other technologies.

Exemplarily, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, a non-transitory computer-readable storage medium, for example, memory 804 including a computer program instruction, is also provided. The computer program instruction may be executed by a processing component 820 of an electronic device 800 to implement the abovementioned method.

The embodiments of the present disclosure further provide a computer program product, which may include a computer-readable code; and when the computer-readable code runs in a device, a processor in the device executes the method for neutral network training provided by the above any embodiment.

An embodiment of the present disclosure further provides another computer program product, configured to store a computer-readable instruction; and the instruction is executed to cause a computer to execute operations of the image generation method provided by any of the above embodiments.

The computer program product may be specifically implemented through hardware, software or a combination thereof. In an optional embodiment, the computer program product is specifically embodied as a computer storage medium; and in another embodiment, the computer program product is specifically embodied as a software product, such as a Software Development Kit (SDK).

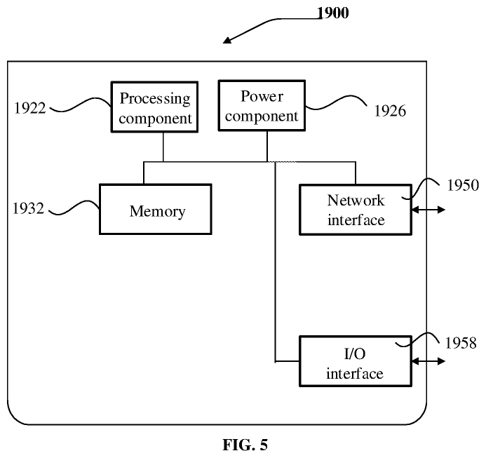

FIG. 5 illustrates a block diagram of an electronic apparatus 1900 according to an exemplary embodiment. For example, the electronic device 1900 may be provided as a server. Referring to FIG. 5, the electronic device 1900 includes a processing component 1922, further including one or more processors, and memory resource represented by memory 1932, configured to store instructions executable by the processing component 1922, for example, an application program. The application program stored in the memory 1932 may include one or more modules, with each module corresponding to one group of instructions. In addition, the processing component 1922 is configured to execute the instruction to execute the abovementioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

In an exemplary embodiment, a non-transitory computer-readable storage medium, for example, memory 1932 including computer program instructions, is also provided. The computer program instruction may be executed by a processing component 1922 of an electronic device 1900 to implement the abovementioned method.

The present disclosure may be a system, a method and/or a computer program product. The computer program product may include a computer-readable storage medium, in which a computer-readable program instruction configured to enable a processor to implement each aspect of the present disclosure is stored

The computer-readable storage medium may be a physical device capable of retaining and storing an instruction used by an instruction execution device. The computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as an Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the present disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely or partially executed in a computer of a user, executed as an independent software package, executed partially in the computer of the user and partially in a remote computer, or executed completely in the remote server or a server. In a case involved in the remote computer, the remote computer may be connected to the user computer via an type of network including the LAN or the WAN, or may be connected to an external computer (such as using an Internet service provider to provide the Internet connection). In some examples, an electronic circuit, such as a programmable logic circuit, a Field Programmable Gate Array (FPGA) or a Programmable Logic Array (PLA), is customized by using state information of the computer-readable program instruction. The electronic circuit may execute the computer-readable program instruction to implement each aspect of the present disclosure.

According to the above disclosure, a first random vector is input to a generator to obtain a first generated image, the first generated image and a first real image are input to a discriminator to obtain a first discriminated distribution of the first generated image and a second discriminated distribution of the first real image, the first discriminated distribution represents a probability distribution of a real extent of the first generated image and the second discriminated distribution represents a probability distribution of a real extent of the first real image, a first network loss of the discriminator is determined based on the first discriminated distribution, the second discriminated distribution, a preset first target distribution and a preset second target distribution. The first target distribution is a target probability distribution of a generated image, and the second target distribution is a target probability distribution of a real image. A second network loss of the generator is determined based on the first discriminated distribution and the second discriminated distribution. Adversarial training is performed on the generator and the discriminator based on the first network loss and the second network loss.

Accordingly, the discriminator may output the discriminated distribution for the input image and describe the realness of the input image through the probability distribution. The probability that the input image is the real image may be described from such aspects as color, texture, proportion and background, and thus the realness of the input image may be considered from multiple aspects, such that an information loss is reduced, more comprehensive supervision information and a more accurate training direction are provided for neutral network training and the training precision is improved. The quality of the generated image is also improved, and thus the generator may be applied to generation of a high-definition image. Furthermore, the target probability distribution of the generated image and the target probability distribution of the real image may be preset to guide the training process, and the real image and the generated image may be guided to approach to their respective target probability distributions in the training process, such that the discrimination between the real image and the generated image is increased, the capability of the discriminator to discriminate the real image and the generated image is enhanced, and thus the quality of the image generated by the generator is improved.

In an implementation, the operation that the first network loss of the discriminator is determined based on the first discriminated distribution, the second discriminated distribution, the preset first target distribution and the preset second target distribution may include the following operations.

A first distribution loss of the first generated image is determined based on the first discriminated distribution and the first target distribution.

A second distribution loss of the first real image is determined based on the second discriminated distribution and the second target distribution.

The first network loss is determined based on the first distribution loss and the second distribution loss.

In such a manner, the target probability distribution of the generated image and the target probability distribution of the real image may be preset to guide the training process, distribution losses may be determined, and the real image and the generated image may be guided to approach to their respective target probability distributions in the training process, such that the discrimination between the real image and the generated image is increased, more accurate angular information and a more accurate training direction are provided for the discriminator, the capability of the discriminator to discriminate the real image and the generated image is enhanced, and thus the quality of the image generated by the generator is improved.

In an implementation, the operation that the first distribution loss of the first generated image is determined based on the first discriminated distribution and the first target distribution may include the following operations.

The first discriminated distribution is mapped to a support set of the first target distribution to obtain a first mapping distribution.

A first relative entropy between the first mapping distribution and the first target distribution is determined.

The first distribution loss is determined based on the first relative entropy.

In an implementation, the operation that the second distribution loss of the first real image is determined based on the second discriminated distribution and the second target distribution may include the following operations.

The second discriminated distribution is mapped to a support set of the second target distribution to obtain a second mapping distribution.

A second relative entropy between the second mapping distribution and the second target distribution is determined.

The second distribution loss is determined based on the second relative entropy.

In an implementation, the operation that the first network loss is determined based on the first distribution loss and the second distribution loss may include the following operation.

Weighted summation processing is performed on the first distribution loss and the second distribution loss to obtain the first network loss.

In an implementation, the operation that the second network loss of the generator is determined based on the first discriminated distribution and the second discriminated distribution may include the following operations.

A third relative entropy between the first discriminated distribution and the second discriminated distribution is determined.

The second network loss is determined based on the third relative entropy.

In such a manner, the generator may be trained by reducing a difference between the first discriminated distribution and the second discriminated distribution, such that the performance of the discriminator is improved and the improvement in the performance of the generator is promoted. The generated image with a high real extent may be generated, and the generator may be applied to the generation of a high-definition image.

In an implementation, the operation that Adversarial training is performed on the generator and the discriminator based on the first network loss and the second network loss may include the following operations.

A network parameter of the discriminator is adjusted based on the first network loss.

A network parameter of the generator is adjusted based on the second network loss.

Trained generator and discriminator are obtained when the discriminator and the generator meet a training condition.

In an implementation, the operation that the network parameter of the discriminator is adjusted based on the first network loss may include the following operations.

A second random vector is input to the generator to obtain a second generated image.

Interpolation processing is performed on a second real image based on the second generated image to obtain an interpolated image.

The interpolated image is input to the discriminator to obtain a third discriminated distribution of the interpolated image.

A gradient of the network parameter of the discriminator is determined based on the third discriminated distribution.

A gradient punishment parameter is determined based on the third discriminated distribution when the gradient is larger than or equal to a gradient threshold.

The network parameter of the discriminator is adjusted based on the first network loss and the gradient punishment parameter.

In such a manner, the gradient descending speed of the discriminator during training may be limited by detecting whether the gradient of the network parameter of the discriminator is larger than or equal to the gradient threshold, thereby limiting the training progress of the discriminator and reducing a probability that the discriminator has a vanishing gradient. Thus, the generator may be optimized sustainably, the performance of the generator is improved, the real extent of an image generated by the generator is high, and the generator may be applied to generation of a high-definition image.

In an implementation, the operation that adversarial training is performed on the generator and the discriminator based on the first network loss and the second network loss may include the following operations.

The first random vector input to a generator in at least one historical training period is input to a generator in a present training period to obtain at least one third generated image.

The first generated image corresponding to the first random vector input to the generator in the at least one historical training period, the at least one third generated image and at least one real image are input to a discriminator in the present training period to obtain a fourth discriminated distribution of at least one first generated image, a fifth discriminated distribution of the at least one third generated image and a sixth discriminated distribution of the at least one real image.

A training progress parameter of the generator in the present training period is determined based on the fourth discriminated distribution, the fifth discriminated distribution and the sixth discriminated distribution.

The network parameter of the discriminator is stopped from being adjusted but only the network parameter of the generator is adjusted when the training progress parameter is smaller than or equal to a training progress threshold.

In such a manner, the gradient descending speed of the discriminator during training may be limited by checking the training progress of each of the discriminator and the generator, thereby limiting the training progress of the discriminator and reducing the probability that the discriminator has the vanishing gradient. The generator may be optimized sustainably, the performance of the generator is improved, the real extent of an image generated by the generator is high, and the generator may be applied to generation of a high-definition image.

In an implementation, the operation that the training progress parameter of the generator in the present training period is determined based on the fourth discriminated distribution, the fifth discriminated distribution and the sixth discriminated distribution may include the following operations.

A first expected value of the at least one fourth discriminated distribution, a second expected value of the at least one fifth discriminated distribution and a third expected value of the at least one sixth discriminated distribution are acquired.

A first average value of the at least one first expected value, a second average value of the at least one second expected value and a third average value of the at least one third expected value are acquired.

A first difference between the third average value and the second average value as well as a second difference between the second average value and the first average value is determined.

A ratio of the first difference to the second difference is determined as the training progress parameter of the generator in the present training period.

According to an aspect of the present disclosure, a method for image generation is provided, which may include the following operations.

A third random vector is acquired.

The third random vector is input to a trained generator and processed to obtain a target image.

Herein, each aspect of the present disclosure is described with reference to flowcharts and/or block diagrams of the method, device (system) and computer program product according to the embodiments of the present disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating operations are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the present disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the present disclosure has been described above. The above descriptions are exemplary, non-exhaustive and also not limited to each disclosed embodiment. Many modifications and variations are apparent to those of ordinary skill in the art without departing from the scope and spirit of each described embodiment of the present disclosure. The terms used herein are selected to explain the principle and practical application of each embodiment or technical improvements in the market best or enable others of ordinary skill in the art to understand each embodiment disclosed herein.

1. A method for neutral network training, comprising:
inputting a first random vector to a generator to obtain a first generated image;
inputting the first generated image and a first real image to a discriminator to obtain a first discriminated distribution of the first generated image and a second discriminated distribution of the first real image, wherein the first discriminated distribution represents a probability distribution of a real extent of the first generated image, and the second discriminated distribution represents a probability distribution of a real extent of the first real image;
determining a first network loss of the discriminator based on the first discriminated distribution, the second discriminated distribution, a preset first target distribution and a preset second target distribution, wherein the preset first target distribution is a target probability distribution of a generated image, and the preset second target distribution is a target probability distribution of a real image;
determining a second network loss of the generator based on the first discriminated distribution and the second discriminated distribution; and
performing adversarial training on the generator and the discriminator based on the first network loss and the second network loss.

2. The method of claim 1, wherein determining the first network loss of the discriminator based on the first discriminated distribution, the second discriminated distribution, the preset first target distribution and the preset second target distribution comprises:
determining a first distribution loss of the first generated image based on the first discriminated distribution and the preset first target distribution;
determining a second distribution loss of the first real image based on the second discriminated distribution and the preset second target distribution; and
determining the first network loss based on the first distribution loss and the second distribution loss.

3. The method of claim 2, wherein determining the first distribution loss of the first generated image based on the first discriminated distribution and the preset first target distribution comprises:
mapping the first discriminated distribution to a support set of the preset first target distribution to obtain a first mapping distribution;
determining a first relative entropy between the first mapping distribution and the preset first target distribution; and
determining the first distribution loss based on the first relative entropy.

4. The method of claim 2, wherein determining the second distribution loss of the first real image based on the second discriminated distribution and the preset second target distribution comprises:
mapping the second discriminated distribution to a support set of the preset second target distribution to obtain a second mapping distribution;
determining a second relative entropy between the second mapping distribution and the preset second target distribution; and
determining the second distribution loss based on the second relative entropy.

5. The method of claim 2, wherein determining the first network loss based on the first distribution loss and the second distribution loss comprises:
performing weighted summation processing on the first distribution loss and the second distribution loss to obtain the first network loss.

6. The method of claim 1, wherein determining the second network loss of the generator based on the first discriminated distribution and the second discriminated distribution comprises:
determining a third relative entropy between the first discriminated distribution and the second discriminated distribution; and
determining the second network loss based on the third relative entropy.

7. The method of claim 1, wherein performing adversarial training on the generator and the discriminator based on the first network loss and the second network loss comprises:
adjusting a network parameter of the discriminator based on the first network loss;
adjusting a network parameter of the generator based on the second network loss; and
obtaining trained generator and discriminator when the discriminator and the generator meet a training condition.

8. The method of claim 7, wherein adjusting the network parameter of the discriminator based on the first network loss comprises:
inputting a second random vector to the generator to obtain a second generated image;
performing interpolation processing on a second real image based on the second generated image to obtain an interpolated image;
inputting the interpolated image to the discriminator to obtain a third discriminated distribution of the interpolated image;
determining a gradient of the network parameter of the discriminator based on the third discriminated distribution;
determining a gradient punishment parameter based on the third discriminated distribution when the gradient is larger than or equal to a gradient threshold; and
adjusting the network parameter of the discriminator based on the first network loss and the gradient punishment parameter.

9. The method of claim 7, wherein performing adversarial training on the generator and the discriminator based on the first network loss and the second network loss comprises:
inputting the first random vector input to a generator in at least one historical training period to a generator in a present training period to obtain at least one third generated image;
inputting the first generated image corresponding to the first random vector input to the generator in the at least one historical training period, the at least one third generated image and at least one real image to a discriminator in the present training period to obtain a fourth discriminated distribution of each of at least one first generated image, a fifth discriminated distribution of each of the at least one third generated image and a sixth discriminated distribution of each of the at least one real image;
determining a training progress parameter of the generator in the present training period based on the at least one fourth discriminated distribution, the at least one fifth discriminated distribution and the at least one sixth discriminated distribution; and
stopping adjusting the network parameter of the discriminator but only adjusting the network parameter of the generator when the training progress parameter is smaller than or equal to a training progress threshold.

10. The method of claim 9, wherein determining the training progress parameter of the generator in the present training period based on the at least one fourth discriminated distribution, the at least one fifth discriminated distribution and the at least one sixth discriminated distribution comprises:
acquiring a first expected value of each of the at least one fourth discriminated distribution, a second expected value of each of the at least one fifth discriminated distribution and a third expected value of each of the at least one sixth discriminated distribution;
acquiring a first average value of the at least one first expected value, a second average value of the at least one second expected value and a third average value of the at least one third expected value;
determining a first difference between the third average value and the second average value as well as a second difference between the second average value and the first average value; and
determining a ratio of the first difference to the second difference as the training progress parameter of the generator in the present training period.

11. An apparatus for image generation, comprising:
a processor; and
memory, configured to store instructions executable by the processor,
wherein the processor is configured to:
acquire a third random vector; and
input the third random vector to a generator and processing the third random vector to obtain a target image,
wherein the processor is further configured to train the generator by a method comprising:
inputting a first random vector to the generator to obtain a first generated image;
inputting the first generated image and a first real image to a discriminator to obtain a first discriminated distribution of the first generated image and a second discriminated distribution of the first real image, wherein the first discriminated distribution represents a probability distribution of a real extent of the first generated image, and the second discriminated distribution represents a probability distribution of a real extent of the first real image;
determining a first network loss of the discriminator based on the first discriminated distribution, the second discriminated distribution, a preset first target distribution and a preset second target distribution, wherein the preset first target distribution is a target probability distribution of a generated image and the preset second target distribution is a target probability distribution of a real image;
determining a second network loss of the generator based on the first discriminated distribution and the second discriminated distribution; and
performing adversarial training on the generator and the discriminator based on the first network loss and the second network loss.

12. An apparatus for neutral network training, comprising:
a processor; and
memory, configured to store instructions executable by the processor,
wherein the processor is configured to:
input a first random vector to a generator to obtain a first generated image;
input the first generated image and a first real image to a discriminator to obtain a first discriminated distribution of the first generated image and a second discriminated distribution of the first real image, wherein the first discriminated distribution represents a probability distribution of a real extent of the first generated image, and the second discriminated distribution represents a probability distribution of a real extent of the first real image;
determine a first network loss of the discriminator based on the first discriminated distribution, the second discriminated distribution, a preset first target distribution and a preset second target distribution, wherein the preset first target distribution is a target probability distribution of a generated image, and the preset second target distribution is a target probability distribution of a real image;
determine a second network loss of the generator based on the first discriminated distribution and the second discriminated distribution; and
perform adversarial training on the generator and the discriminator based on the first network loss and the second network loss.

13. The apparatus of claim 12, wherein the processor is further configured to:
determine a first distribution loss of the first generated image based on the first discriminated distribution and the preset first target distribution;
determine a second distribution loss of the first real image based on the second discriminated distribution and the preset second target distribution; and
determine the first network loss based on the first distribution loss and the second distribution loss.

14. The apparatus of claim 13, wherein the processor is further configured to:
map the first discriminated distribution to a support set of the preset first target distribution to obtain a first mapping distribution, determine a first relative entropy between the first mapping distribution and the preset first target distribution, and determine the first distribution loss based on the first relative entropy; or
map the second discriminated distribution to a support set of the preset second target distribution to obtain a second mapping distribution, determine a second relative entropy between the second mapping distribution and the preset second target distribution, and determine the second distribution loss based on the second relative entropy; or
perform weighted summation processing on the first distribution loss and the second distribution loss to obtain the first network loss.

15. The apparatus of claim 12, wherein the processor is further configured to:
determine a third relative entropy between the first discriminated distribution and the second discriminated distribution; and
determine the second network loss based on the third relative entropy.

16. The apparatus of claim 12, wherein the processor is further configured to:
adjust a network parameter of the discriminator based on the first network loss;
adjust a network parameter of the generator based on the second network loss; and
obtain trained generator and discriminator when the discriminator and the generator meet a training condition.

17. The apparatus of claim 16, wherein the processor is further configured to:
input a second random vector to the generator to obtain a second generated image;
perform interpolation processing on a second real image based on the second generated image to obtain an interpolated image;
input the interpolated image to the discriminator to obtain a third discriminated distribution of the interpolated image;
determine a gradient of the network parameter of the discriminator based on the third discriminated distribution;
determine a gradient punishment parameter based on the third discriminated distribution when the gradient is larger than or equal to a gradient threshold; and
adjust the network parameter of the discriminator based on the first network loss and the gradient punishment parameter.

18. The apparatus of claim 16, wherein the processor is further configured to:
input the first random vector input to a generator in at least one historical training period to a generator in a present training period to obtain at least one third generated image;
input the first generated image corresponding to the first random vector input to the generator in the at least one historical training period, the at least one third generated image and at least one real image to a discriminator in the present training period to obtain a fourth discriminated distribution of each of at least one first generated image, a fifth discriminated distribution of each of the at least one third generated image and a sixth discriminated distribution of each of the at least one real image;
determine a training progress parameter of the generator in the present training period based on the at least one fourth discriminated distribution, the at least one fifth discriminated distribution and the at least one sixth discriminated distribution; and
stop adjusting the network parameter of the discriminator but only adjust the network parameter of the generator when the training progress parameter is smaller than or equal to a training progress threshold.

19. The apparatus of claim 18, wherein the processor is further configured to:
acquire a first expected value of each of the at least one fourth discriminated distribution, a second expected value of each of the at least one fifth discriminated distribution and a third expected value of each of the at least one sixth discriminated distribution;
acquire a first average value of the at least one first expected value, a second average value of the at least one second expected value and a third average value of the at least one third expected value;
determine a first difference between the third average value and the second average value as well as a second difference between the second average value and the first average value; and
determine a ratio of the first difference to the second difference as the training progress parameter of the generator in the present training period.

20. A non-transitory computer-readable storage medium, storing computer program instructions that, when executed by a processor, implement the method of claim 1.
